(19) United States
(12) Patent Application Publication
(10) Pub. No.: US 2011/0122656 A1
(43) Pub. Date: May 26, 2011

(54) POWER DEVICE WITH ISOLATED VARYING-FREQUENCY PWM CONTROL

(76) Inventor: CHANG-HSING CHEN, Hsin Chuang City (TW)

(21) Appl. No.: 12/626,563

(22) Filed: Nov. 25, 2009

(51) Int. Cl. H02M 3/335

(52) U.S. Cl. 363/16

(57) ABSTRACT

A power device with isolated varying-frequency PWM control contains a transformer having a primary side and a secondary side; a varying-frequency PWM chip located at the secondary side, the varying-frequency PWM chip containing a frequency adjustment circuit and PWM control circuit, the PWM control circuit having at least an output terminal; a sampling circuit connected to the varying-frequency PWM chip; and a separation circuit having at least a terminal connected to the varying-frequency PWM chip; wherein the at least one terminal of the PWM control circuit drives a switch so that various types of transformer is applicable; the frequency adjustment circuit of the varying-frequency PWM chip dynamically adjusts a periodic signal's frequency according to load condition so that a pulse signal from the PWM control circuit is adjusted as well to reduce switching loss and to enhance energy conservation.

### (a) TECHNICAL FIELD OF THE INVENTION

The present invention generally relates to power devices utilizing PWM control, and more particularly relates to a power device whose PWM control is isolated from the primary side of the transformer for reducing switching loss and enhancing energy conservation.

### (b) DESCRIPTION OF THE PRIOR ART

As shown in FIG. 1 which is taught by U.S. Pat. No. 6,212,079, a switching regulator 83 is connected between a primary side 811 of a transformer 81 and an opto-coupler 82. Within the switching regulator 83, there is a power switch 832 and a control circuit 831 connected to the power switch 832. The control circuit 831 contains PWM (pulse-width-modulation) circuit, feedback signal circuit, and timer circuit. On the other hand, the opto-coupler 82 is connected to an output sense circuit 84 which in turn connected to a load at a secondary side 812 of the transformer 81. According to the teaching, the power switch 832 is engaged directly by the control circuit 831 so as to achieve frequency adjustment.

However, the power switch 832 and the control circuit 831 are together housed in the switching regulator 83, leading to a heat dissipation issue and limited output power from the control circuit 831. On the other hand, the control circuit 831 has a single output terminal 8311 and thereby could only control a single, not multiple, power switch 832. As such, the switching regulator 83 is applicable only with a feedback transformer. The varieties of the transformer 81 are therefore limited.

Further, as the switching regulator 83 is located at the primary side 811 of the transformer 81, it is directly exposed to the high voltage and high noise at the primary side 811. In order to protect the switching regulator 83 against these influences, additional manufacturing processes are required and production cost is increased. In addition, as there is always some limitation on the working frequency of the transformer 81 and the power switch 832, the transformer 81 and the power switch 832 cannot reduce their working frequencies as the load is continuously decreased, even below a default value. The switching loss is therefore still present even when there is no load present, significantly reducing the no-load efficiency.

### SUMMARY OF THE INVENTION

The present invention provides a power device with isolated varying-frequency PWM control contains:

a transformer having a primary side and a secondary side;

a varying-frequency PWM chip located at the secondary side, the varying-frequency PWM chip containing a frequency adjustment circuit and PWM control circuit, the PWM control circuit having at least an output terminal;

a sampling circuit connected to the varying-frequency PWM chip; and

a separation circuit having at least a terminal connected to the varying-frequency PWM chip;

wherein the at least one terminal of the PWM control circuit drives a switch so that various types of transformer is applicable; the frequency adjustment circuit of the varying-frequency PWM chip dynamically adjusts a periodic signal's frequency according to load condition so that a pulse signal from the PWM control circuit is adjusted as well to reduce switching loss and to enhance energy conservation.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic diagram of a conventional power device.

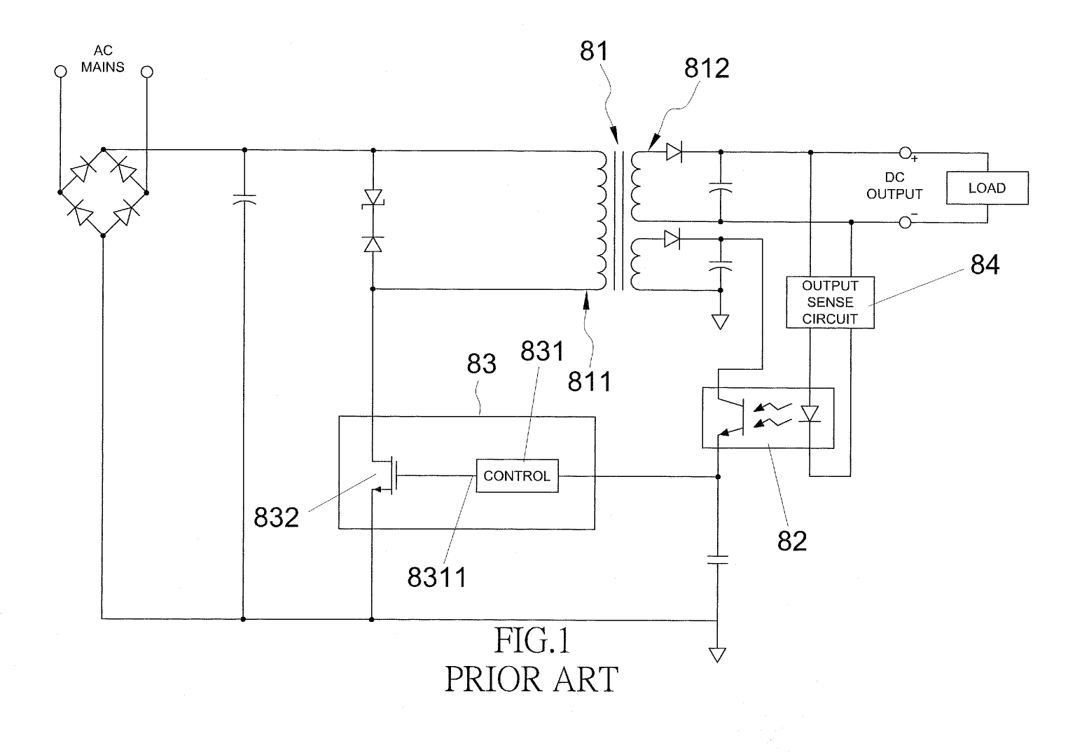

FIG. 2 is a functional block diagram of a power device according to a first embodiment of the present invention.

FIG. 3 is a functional block diagram showing the internal of a varying-frequency PWM chip of FIG. 2.

FIG. 4 is a functional block diagram showing the internal of a frequency adjustment circuit of FIG. 3.

FIG. 5 is a schematic diagram showing the frequency adjustment circuit of FIG. 4.

FIG. 6 is a signal diagram showing the relationship between a periodic signal of the frequency adjustment circuit and a pulse signal of a PWM control circuit.

FIG. 7 is a functional block diagram of a power device according to a second embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

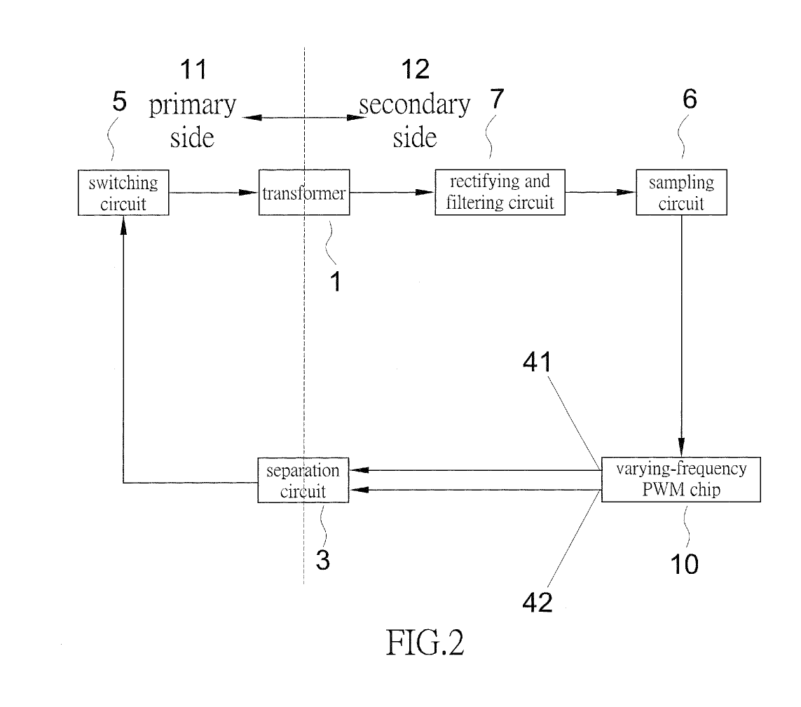

As shown in FIG. 2, a power device according to a first embodiment of the present invention contains the following components.

A transformer 1, which could be a half-bridge, full-bridge, push-pull, inverter, feedback, or forward transformer, has a primary side 11 and a secondary side 12.

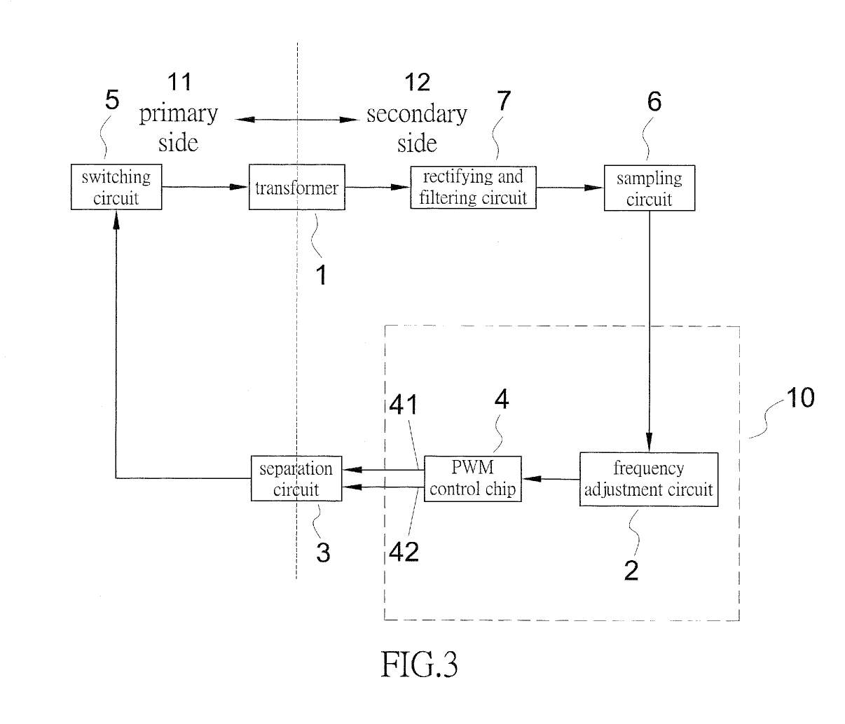

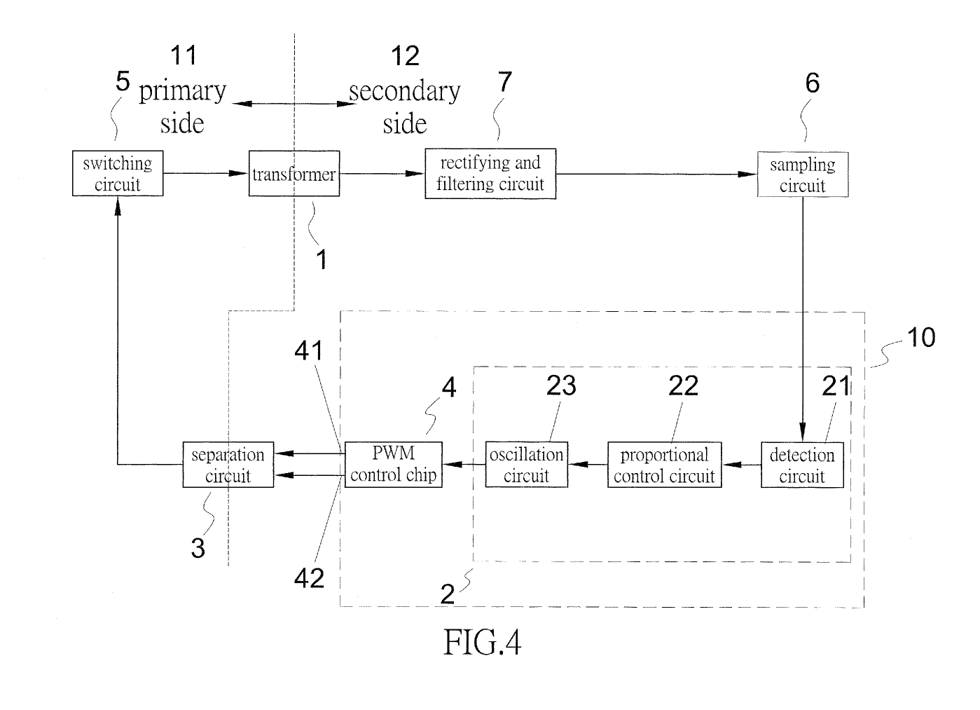

A varying-frequency pulse-width-modulation (PWM) chip 10 is located at the secondary side 12 of the transformer 1. As further shown in FIG. 3, the varying-frequency PWM chip 10 contains a frequency adjustment circuit 2, which in turn as shown in FIG. 4, contains a detection circuit 21, a proportional control circuit 22, and an oscillation circuit 23. The detection circuit 21 could be a voltage sensing or current sensing circuit. The proportional control circuit 22 is connected to the detection circuit 21 and the oscillation circuit 23. The varying frequency PWM chip 10 further contains a PWM control circuit 4 which is connected to the oscillation circuit 23 of the frequency adjustment circuit 2. The PWM control chip 4 has at least an output terminal (two output terminals 41 and 42 are shown). The output on the output terminals 41 and 42 could be synchronous or asynchronous.

A sampling circuit 6 is connected to the varying-frequency PWM chip 10 and, on the other hand, there is a rectifying and filtering circuit 7 located between the secondary side 12 of the transformer 1 and the sampling circuit 6.

A separation circuit 3 is connected to the varying-frequency PWM chip 10. The separation circuit 3 contains a separation element (not shown) which could be a transformer, opto-coupler, or magnetic element. A switching circuit 5 is located between the primary side 11 of the transformer 1 and the separation circuit 3. The switching circuit 5 contains at least a switch element (not shown) which could be a MOSFET, insulated gate bipolar transistor (IGBT), or bipolar junction transistor (BJT).

Through the at least one output terminal 41 or 42 from the PWM control circuit 4, the switch in the switching circuit 5 is driven and the power device of the present invention is applicable to a high-rating power circuit and various transformer 1. In addition, as the varying-frequency PWM chip 10 is connected to the secondary side 12 of the transformer 1, the varying-frequency PWM chip 10 is prevented from being damaged by the high voltage or noise from the primary side 11 of the transformer 1. The production cost for implementing the power device in integrated circuit is also significantly reduced.

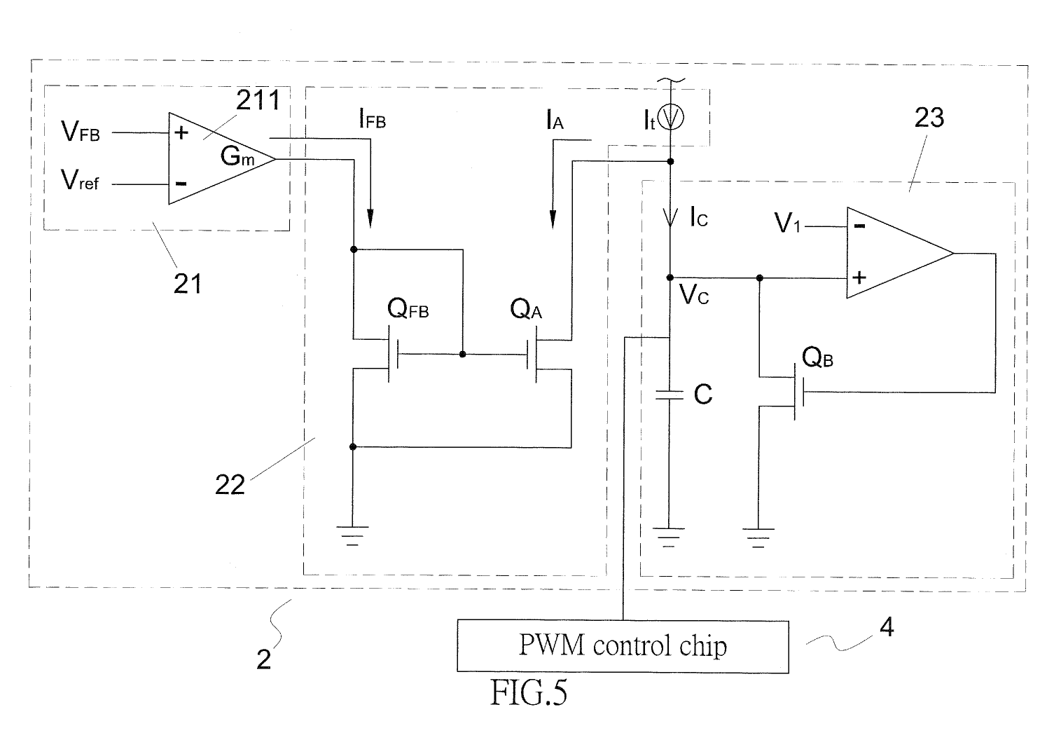

As shown in FIGS. 3 and 4, by connecting the sampling circuit 6 to the frequency adjustment circuit 2 of the varying-frequency PWM chip 10, the load condition monitored by the sampling circuit 6 is delivered to the detection circuit 21 of the frequency adjustment circuit 2. As further shown in FIG. 5, a feedback voltage V_{FB} from the load is received by an input terminal of the frequency adjustment circuit 2, which is compared against an internal reference voltage V_{ref}. When the load decreases, the feedback voltage V_{FB} also decreases; on the other hand, when the load increases, the feedback voltage V_{FB} increases as well.

As shown in FIGS. 4 and 5, the comparison between the feedback voltage V_{FB} and the internal reference voltage V_{ref} is converted by a conversion element 211 into a corresponding current I_{FB} which is reversely proportional to the feedback voltage V_{FB}. Therefore, when the feedback voltage V_{FB} decreases and the load decreases, the output current I_{FB} from the detection circuit 21 increases.

As shown in FIG. 5, as the output current I_{FB} flows into a MOSFET Q_{FB} of the proportional control circuit 22, the MOSFET Q_{FB} conducts when the output current I_{FB} from the detection circuit 21 increases. In turn, another MOSFET Q_{A} connected to a constant current source I also conducts and, therefore, a branch current I_{A} from the current source I increases. A charging current I_{C} from the current source I is thereby lowered. As such, a capacitor C of the oscillation circuit 23 is charged at a slower rate (the charging time t1 increases) and the voltage V_{C} across the capacitor C rises slowly. When the capacitor C is charged so that V_{C} reaches an internal voltage V₁, a MOSFET Q_{B} is turned on so that the capacitor C discharges through the MOSFET Q_{B}. A periodic signal 24 with interval T1 from the oscillation circuit 23 is thus produced. When the charging current I_{C} decreases, as described, the interval T1 increases and the frequency of the periodic signal 24 decreases, thereby achieving the objective of decreasing the frequency of the periodic signal 24.

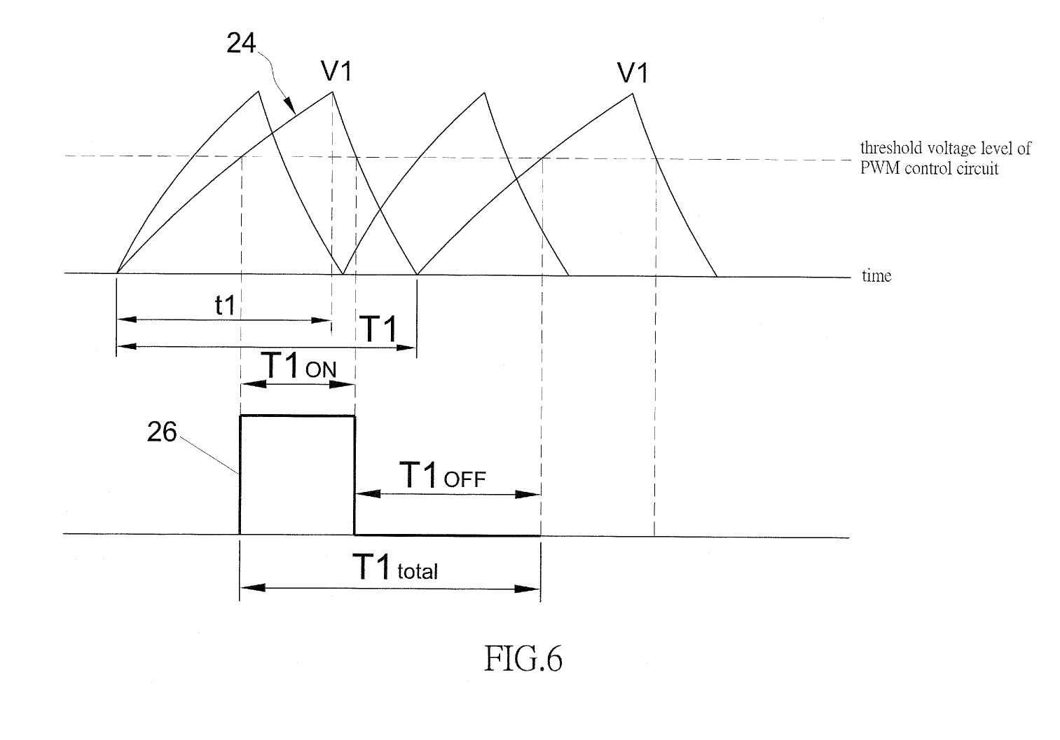

As shown in FIGS. 5 and 6, as the PWM control circuit 41 is connected to the frequency adjustment circuit 2 and receives the periodic signal 24 from the oscillation circuit 23, a pulse signal 26 produced by the PWM control circuit 41 would have increased on interval (T1_{ON}) and off interval (T1_{OFF}), and thereby the total interval T1ₜₒₜₐₗ, as the frequency of the periodic signal 24 drops. In other words, the frequency of the pulse signal 26 is reduced along with the periodic signal 24.

As shown in FIG. 2, by configuring the rectifying circuit 7 between the secondary side 12 of the transformer 1 and the sampling circuit 6, the varying-frequency PWM chip 10 between the sampling circuit 6 and the separation circuit 3, and locating the varying-frequency chip 10 at the secondary side 12 of the transformer 1, the frequency of the periodic signal 24 of the varying-frequency PWM chip 10 is dynamically adjusted in accordance with the load so that the frequency of the pulse signal 26 of the PWM control circuit 4 is adjusted as well. In addition, by having the separation circuit 3's one end connected to the output terminals 41, 42 of the varying-frequency PWM chip 10 and the other end connected to the switching circuit 5, the switching loss of the switching circuit 5 and the rectifying and filtering circuit 7 is significantly reduced, thereby enhancing the performance of energy conservation.

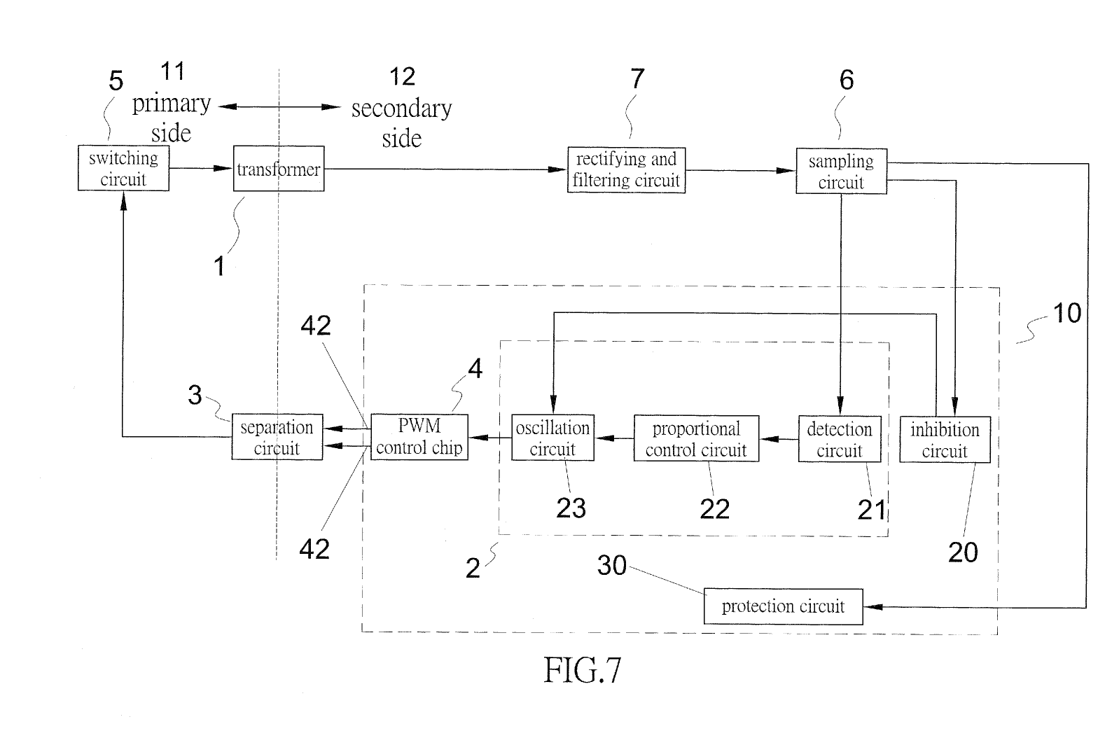

As mentioned that the transformer 1 and the switching circuit 5 usually have limitations on operation frequency and, when the load is continuously reduced, the transformer 1 and the switching circuit 5 cannot reduce their operation frequency without limitation, a second embodiment of the present invention therefore provides an inhibition circuit 20 in the varying-frequency PWM chip 10, as shown in FIG. 7. As illustrated, the sampling circuit 6 is now connected both to the detection circuit 21 and the inhibition circuit 20 so that the load condition is delivered to the detection circuit 21 and the inhibition circuit 20 simultaneously. When the load condition reflects that the load is below a default value, the inhibition circuit 20 would assume that there is no load present and, as the inhibition circuit 20 is connected to the oscillation circuit 23, the inhibition circuit 20 is able to disable the oscillation circuit 23 to stop producing periodic signal 24 temporarily. The pulse signal 26 from the PWM control circuit 4 is therefore stopped as well. In turn, the switching circuit 5 stops and therefore there is no switching loss when there is no load. The present invention as such enjoys enhanced no-load efficiency.

When the load is restored and rises above the default value, or when the output from the rectifying and filtering circuit 7 is below a default level of the inhibition circuit 20, the condition is delivered to the inhibition circuit 20 by the sampling circuit 6. The inhibition circuit 20 would immediately stop its inhibition action, the charging current I_{C} resumes charging the capacitor C inside the oscillation circuit 23, and the periodic signal 24 is produced.

Again as shown in FIG. 7, a protection circuit 30 is provided in the varying-frequency PWM chip 10. The protection circuit 30 is also connected to the sampling circuit 6. The varying-frequency PWM chip 10 now contains frequency adjustment circuit 2, PWM control circuit 4, and inhibition circuit 20, in addition to the protection circuit 30. The varying-frequency PWM chip 10's being located at the secondary side 12 of the transformer 1 allows the varying-frequency PWM chip 10 to be a functional module adaptable to various needs. The cost of the present invention is therefore significantly reduced, thereby achieving a low-cost power device with adaptive PWM control.

A comparison between the prior art and the present invention is provided as follows.

The prior art has the following disadvantages. Firstly, only feedback transformer is applicable, limiting the types of transformers that could be utilized. Secondly, switching regulator could be easily damaged by the high voltage and noise at the primary side of the transformer. Thirdly, there is a high production cost for integrated circuit application. Finally, switching loss is inevitable even when there is no load, reducing the no-load efficiency.

In contrast, the present invention has the following advantages. Firstly, various transformers are applicable. Secondly, the varying-frequency PWM chip is immune from the high voltage and noise at the primary side of the transformer. Thirdly, the varying-frequency PWM chip could be adapted to cover various needs and the cost of integrated circuit application is significantly lowered. Fourthly, the periodic signal's frequency is dynamically adjusted according to the load condition. Fifthly, the PWM control circuit could dynamically adjust its pulse signal, significantly reducing the switching loss of the switching circuit and the rectifying and filtering circuit. Sixthly, switching circuit is inhibited when there is no load to enhance no-load efficiency. Finally, the present invention is applicable to high-rating power circuit for enhanced energy conservation.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A power device with isolated varying-frequency PWM control, comprising:
a transformer having a primary side and a secondary side;
a varying-frequency PWM chip located at said secondary side, said varying-frequency PWM chip containing a frequency adjustment circuit and a PWM control circuit, said PWM control circuit having at least a output terminal;
a sampling circuit connected to said varying-frequency PWM chip; and
a separation circuit having at least a terminal connected to said varying-frequency PWM chip.

2. The power device according to claim 1, wherein said transformer is one of a half-bridge transformer, a full-bridge transformer, a push-pull transformer, an inverter transformer, a feedback transformer, and a forward transformer.

3. The power device according to claim 1, wherein said frequency adjustment circuit contains a detection circuit, a proportional control circuit connected to said detection circuit, and an oscillation circuit connected to said proportional circuit; said PWM control circuit has at least an output terminal; and said output terminal provides one of a synchronous output and an asynchronous output.

4. The power device according to claim 3, wherein said detection circuit is one of a voltage sensing circuit and a current sensing circuit.

5. The power device according to claim 1, further comprising a rectifying and filtering circuit located between said secondary side of said transformer and said sampling circuit.

6. The power device according to claim 1, wherein said first isolation circuit contains a separation element which is one of a transformer, an opto-coupler, and a magnetic element.

7. The power device according to claim 1, further comprising a switching circuit located between said primary side of said transformer and said separation circuit, said switching circuit containing at least a switch element which is one of a MOSFET, an IGBT, and a BJT.

8. The power device according to claim 8, wherein said varying-frequency PWM chip further contains an inhibition circuit and a protection circuit.
